(19) United States
(12) Patent Application Publication
(10) Pub. No.: US 2024/0094550 A1
(43) Pub. Date: Mar. 21, 2024

(54) CUSHIONED HEAD-MOUNTABLE DEVICE

(71) Applicant: Apple Inc., Cupertino, CA (US)

(72) Inventor: Paul X. Wang, Cupertino, CA (US)

(21) Appl. No.: 18/456,435

(22) Filed: Aug. 25, 2023

Related U.S. Application Data
(60) Provisional application No. 63/375,988, filed on Sep. 16, 2022.

(51) Int. Cl. G02B 27/01

(52) U.S. Cl. CPC G02B 27/0176

(57) ABSTRACT

An apparatus can include a head-mountable display, a facial interface, a connector between the head-mountable display and the facial interface, a cushion positioned proximate to the connector, and a wearable strap connected to at least one of the head-mountable display or the facial interface. In one example, the cushion includes an aluminum block with an air pocket. In another example, the cushion includes a foam cushion. In certain implementations, the foam cushion defines a channel, the connector being positioned within the channel. In other implementations, the foam cushion includes a foam torus, the connector being positioned inside a center hole of the foam torus.

### CROSS-REFERENCE TO RELATED APPLICATION(S)

This claims priority to U.S. Provisional Patent Application No. 63/375,988, filed 16 Sep. 2022, and entitled “Cushioned Head-Mountable Device,” the entire disclosure of which is hereby incorporated by reference.

### FIELD

The described embodiments relate generally to a head-mountable device. More particularly, the present embodiments relate to a head-mountable device with a cushion that can provide increased comfort and flexure.

### BACKGROUND

Recent advances in portable computing have enabled head-mountable devices that provide augmented and virtual reality (AR/VR) experiences to users. Such head-mountable devices typically include various components such as a display, a viewing frame, a lens, a battery, a motor, speakers, and other components. These components can operate together to provide an immersive user experience. In particular, head mountable-devices include components that help provide a distraction-free setting by blocking or sealing out the outer environment (e.g., ambient light).

Additionally, users have a myriad of different anatomical features, including head size, eye location, cheek and forehead bone structure, and so forth. Unfortunately, conventional head-mountable devices fail to provide a custom, comfortable fit for a fully immersive experience. Indeed, conventional head-mountable devices have rudimentary customization features (if any). For example, users of a conventional head-mountable device may have differing facial structures that the head-mountable device cannot accommodate. This user-to-user variation can create a poor user experience, causing pressure on a user's face from the head-mountable device. Therefore, a head-mountable device capable of dynamically adapting to different user facial profiles while also providing strategically positioned rigidity and support is desired.

### SUMMARY

In at least one example of the present disclosure, an apparatus includes a head-mountable display, a facial interface, a connector between the head-mountable display and the facial interface, a cushion positioned proximate to the connector, and a wearable strap connected to at least one of the head-mountable display or the facial interface. In one example, the cushion includes an aluminum body having a first protrusion and a second protrusion extending from the body. In another example, the cushion includes a foam cushion. In certain implementations, the foam cushion includes a C-channel, the connector being positioned within the C-channel. In other implementations, the foam cushion includes a foam torus, the connector being positioned inside a center hole of the foam torus.

In other examples, the cushion includes a hydraulic cushion. For instance, in some examples, the hydraulic cushion can include a first chamber at least partially filled with liquid, a second chamber, and a fluid path between the first chamber and the second chamber, the second chamber including a spring-enforced wall. Further, in some examples, the connector includes at least one of a forehead connection at a forehead region of a face or a cheek connection at a maxilla region or a zygoma region of the face.

In at least one example, a wearable apparatus of the present disclosure includes a facial interface, a movable display, a pivot connection movably constraining the movable display, and the facial interface at a forehead region of a face, and a foam cushion positioned at least partially around the pivot connection. In particular examples, the wearable apparatus can further include an additional pivot connection at a zygoma region of the face, and an additional foam cushion positioned proximate to the additional pivot connection. In one example, the additional foam cushion tapers away from the additional pivot connection. In another example, the facial interface includes a floating end positioned above the additional foam cushion at the maxilla region. In yet another example, the wearable apparatus further includes an additional pivot connection positioned at the forehead region, wherein the foam cushion extends between the pivot connection and the additional pivot connection. In certain implementations, the foam cushion defines an air pocket between the pivot connection and the additional pivot connection.

In at least one example, a head-mountable device of the present disclosure includes a display, a display frame housing the display, a facial interface, a wearable strap connected to at least one of the display or the facial interface, a light seal between the display and the facial interface, and a cushion positioned on or within at least one of the display frame or the light seal, the cushion including one of a foam cushion or a hydraulic cushion. In one example, the head-mountable device can further include a light seal frame of the light seal, a pivot connection between the facial interface and the light seal frame, and an additional cushion positioned proximate to the pivot connection. In some examples, the cushion includes a first amount of stiffness, and the additional cushion includes a second amount of stiffness less than the first amount of stiffness. In one example, the cushion includes an overmold of foam material. In another example, the cushion includes a first cushion layer material and a second cushion layer material different than the first cushion layer material. In yet another example, the first cushion layer material and the second cushion layer material have non-uniform thicknesses.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 illustrates a top view of a head-mountable device worn on a user head.

FIG. 2 illustrates a front profile view of an example head-mountable device.

FIG. 3 illustrates an example cushion of a head-mountable device.

FIG. 4 illustrates an example foam cushion of a head-mountable device.

FIG. 5 illustrates an example C-channel foam cushion of a head-mountable device.

FIG. 6 illustrates an example torus foam cushion of a head-mountable device.

FIG. 7 illustrates an example tapered foam cushion of a head-mountable device.

FIG. 8 illustrates an example hydraulic cushion of a head-mountable device.

FIG. 9 illustrates a cross-sectional view of an example foam cushion with multiple layers.

FIG. 10 illustrates a head-mountable device implementing an example overmold cushion.

FIG. 11 illustrates a head-mountable device implementing an example display cushion.

FIG. 12 illustrates a head-mountable device implementing an example light seal cushion.

### DETAILED DESCRIPTION

Reference will now be made to representative examples illustrated in the accompanying drawings. The following descriptions are not intended to limit the embodiments to one preferred embodiment. To the contrary, the descriptions are intended to cover alternatives, modifications, and equivalents as can be included within the spirit and scope of the described embodiments as defined by the appended claims.

The following disclosure relates to wearable electronic devices (e.g., a head-mountable device). More particularly, the present embodiments relate to cushions positioned on or within a head-mountable device.

When donning a head-mountable device, or during use, the position and weight of the head-mountable device can affect the quality of the user experience. Indeed, conventional head-mountable devices can be heavy due to the mass of materials (or combination of materials) used in manufacture. The additional weight can apply excess pressure to a user's face causing discomfort and pressure points at certain regions of the face. This user discomfort can degrade the overall AR/VR experience or limit the duration of comfortable use.

Exacerbating the weight factor, facial regions that contact a head-mountable device can have unique facial characteristics, such as variations of cranial width or length, or variations in facial bones (e.g., frontal bone, zygoma, maxilla, etc.). Thus, these areas of high facial variability can undergo acute pressure or lend to faster user exhaustion.

Cushions of the present disclosure address these and/or other issues of conventional head-mountable devices by providing improved flexure and support. Indeed, cushions of the present disclosure can dynamically adjust to the facial variability of users to provide a comfortable user experience. Additionally, cushions (and associated connectors) of the present disclosure can better distribute applied loads across the user face for improved comfort compared to conventional head-mountable devices. Such cushions can include, for instance, block-based cushions (e.g., with air pockets), foam-based cushions, hydraulic cushions, etc. Different implementations of these or other cushions can provide desired amounts of rigidity and/or flexibility.

To illustrate, the cushions of the present disclosure can be positioned at various locations to correspond with certain facial regions (e.g., maxilla, zygoma, frontal bone, etc.). In certain implementations, the cushions disclosed herein are positioned between, or at least partially around, certain connectors (e.g., a forehead connector, a zygoma connector, etc.). The connectors can include various types of joints (e.g., pivot joint, soft joint, flexure joint, spring joint, etc.). The connectors can, in combination with the cushions, provide a comfortable pressure distribution.

Additionally or alternatively, the cushions of the present disclosure can be implemented at other locations besides connector locations. For example, a cushion can be implemented on or within a display frame of a head-mountable device. As another example, a cushion can be implemented on or within a light seal (e.g., between a light seal frame and the display). In yet another example, a cushion can be implemented as an overmold cushion that can at least partially envelop a head-mountable device.

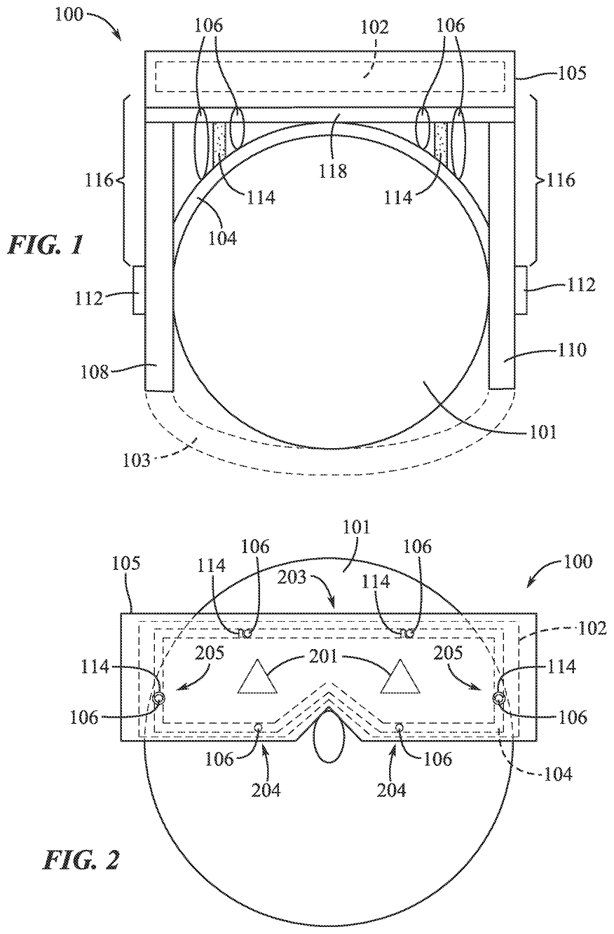

These and other embodiments are discussed below with reference to FIGS. 1-12. However, those skilled in the art will readily appreciate that the detailed description given herein with respect to these Figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates a top view of a head-mountable device 100 worn on a user head 101. The head mountable device can include a display frame 105 that houses a display 102. In addition, the display frame 105 can connect to arms 108, 110 discussed below.

The display 102 includes one or more optical lenses or display screens that are positionable in front of the eyes of the user. The display 102 can include a display for presenting a virtual reality visualization, an augmented reality visualization, or other suitable visualization.

The head-mountable device 100 also includes a facial interface 104. As used herein, the term “facial interface” refers to a portion of the head-mountable device 100 that engages a user face via direct contact. In particular, a facial interface includes portions of the head-mountable device 100 that conform to (e.g., compress against) regions of the user face. For example, a facial interface may include a pliant (or semi-pliant) face track that spans the forehead, wraps around the eyes, contacts the zygoma and maxilla regions of the face, and bridges the nose.

Furthermore, the head-mountable device 100 includes a light seal 116. As used herein, the term “light seal” refers to various components forming a structure, webbing, cover, fabric, or frame of a head-mountable device disposed between the display 102 and the user skin. In particular implementations, a light seal can include a variety of seals (e.g., a light seal, environment seal, dust seal, air seal, etc.). It will be appreciated that the term “seal” can include partial seals or inhibitors, in addition to complete seals (e.g., a partial light seal where some ambient light is blocked and a complete light seal where all ambient light is blocked when the head-mountable device is donned).

In particular examples, the light seal 116 includes a portion of the head-mountable device positioned between the display 102 and the facial interface 104. In certain implementations, the light seal 116 includes a light seal frame 118. The light seal frame 118 can include a structural support member, skeleton, or framework defining the shape or outer periphery of the light seal 116. Additionally or alternatively, the light seal frame 118 can include an intermediary structural member that connects the light seal 116 to at least one of the facial interface 104 or the display 102.

In addition, the head-mountable device 100 includes connector(s) 106. As used herein, the terms “connector” or “joint” refer to a joining between the display 102 (via the display frame 105) and the facial interface 104. In some examples, a connector allows the facial interface 104 to translate or rotate relative to at least one of the light seal frame 118 or the display 102 via the connector. In other examples, the connector allows the facial interface 104 to both translate and rotate relative to at least one of the light seal frame 118 or the display 102. For example, the connector(s) 106, when acted on can translate the facial interface 104 toward or away from the display 102 (e.g., in a linear fashion). In another example, the connector(s) 106 when acted on can rotate the facial interface 104 up or down relative to at least one of the light seal frame 118 or the display 102 (e.g., in an angular fashion). In particular implementations, the connector(s) 106 moveably constrain the facial interface 104 to at least one of the light seal frame 118 or the display 102 at a forehead location, a zygoma location, or a maxilla location.

In this manner, the connector(s) 106 can movably constrain at least one of the light seal frame 118 or the display 102 relative to the facial interface 104. As used herein, the term “movably constrain” refers to the type of connection that can dynamically move (e.g., translate or rotate), yet retain control over a particular element's movement or position. For example, to “movably constrain” means the connector(s) 106 can bound movement of the light seal frame 118 or the display 102 within two degrees of freedom (e.g., along a horizontal plane and along an additional plane non-planar with the horizontal plane) relative to the facial interface 104.

As used herein, the term “forehead region” refers to an area of a human face between the eyes and the scalp of a human. Additionally, the term “maxilla region” refers to an area of a human face corresponding to the zygomatic bone structure of a human. Similarly, the term “maxilla region” refers to an area of a human face corresponding to the maxilla bone structure of a human. Further, the term “temple region” refers to an area of a human face between a respective eye and ear on a particular side of a face (e.g., between cheek bones and a forehead region). It will be appreciated that the foregoing regions can correspond to particular structure of the head-mountable device 100. However, such structure of the head-mountable device 100 is not dependent on a face or a user.

The connector(s) 106 allow the facial interface 104 to conform freely to a wide range of facial topographies, thereby allowing the facial interface 104 to pivot and flex relative to the display 102. The connector(s) 106 can also distribute loads (e.g., forces exerted from different facial topographies or compression from the strap 103) evenly on a user's face. The connector(s) 106 can include one or more joints (e.g., pivot joint, soft joint, flexure joint, spring joint, etc.) that allow (or actively provide) translation or rotation of the facial interface 104 relative to at least one of the light seal frame 118 or the display 102.

Furthermore, locations of the connector(s) 106 can be modified or tuned, as can the number of connections. For example, the location and or number of the connector(s) 106 can correlate to an amount of force or pressure exerted on the user at any one datum (e.g., forehead region, maxilla region, zygoma region, etc.) In particular implementations, one or more of the connector(s) 106 can offload an amount of force or pressure from one or more other connectors. For instance, a connector at the forehead region can offload an amount of force or pressure transferred through another connector at the maxilla or zygoma regions. In other instances, the location and/or the number of connector(s) 106 can correspond to rigidity (or rigidity variances) between the connector(s) 106.

Further shown, cushions 114 can be positioned adjacent to the connector(s) 106. As used herein, the term “cushion” refers to a dampener or other element configured to redirect, slow, or soften applied forces. Examples of a cushion can include a foam element, pliant metal or composite, gel, hydraulic mechanism, etc. Specific implementations of the cushions 114 are described in more detail below in relation to the subsequent figures.

Additionally shown in FIG. 1, the head-mountable device 100 includes one or more arms 108, 110. The arms 108, 110 are connected to the display frame 105 and extend distally toward the rear of the head. The arms 108, 110 are configured to secure the display in a position relative to the user head 101 (e.g., such that the display 102 is maintained in front of a user's eyes). For example, the arms 108, 110 extend over the user's ears 112. In certain examples, the arms 108, 110 rest on the user's ears 112 to secure the head-mountable device 100 via friction between the arms 108, 110 and the user head 101. For example, the arms 108, 110 can apply opposing pressures to the sides of the user head 101 to secure the head-mountable device 100 to the user head 101. Optionally, the arms 108, 110 can be connected to each other via a strap 103 (shown in the dashed lines) that can compress the head-mountable device 100 against the user head 101. In these or other examples, the combination of the arms 108, 110 and the strap 103 can form a wearable strap connected to at least one of the display frame 105, the facial interface 104, or a light seal frame 118 of the light seal 116.

The display frame 105 and the arms 108, 110 can include a variety of different materials. In some examples, the display frame 105 and the arms 108, 110 can include a rigid material (e.g., metal) to provide increased support, protect certain internal components from undesired stresses or strain, and the like. Additionally or alternatively, the display frame 105 and the arms 108, 110 can include a flexible, softer material (e.g., silicone) to provide enhanced flexibility and comfort, particularly at areas prone to contact the user head 101.

Any of the features, components, and/or parts, including the arrangements and configurations thereof shown in FIG. 1 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 1.

FIG. 2 illustrates a front profile view of an example of the head-mountable device 100. As discussed above, the head-mountable device 100 includes (among other elements) the display 102, the facial interface 104, and the connector(s) 106. In particular, as shown in FIGS. 2A-2B, the facial interface 104 can indeed wrap around the eyes 201, bridge the nose 202, span the forehead 203, and contact a maxilla facial region 204 and a zygoma facial region 205. In other implementations, the facial interface 104 can follow a different track around the face. For example, the facial interface 104 can stop between the nose 202 and the maxilla facial region 204 (e.g., such that the facial interface 104 does not contact the nose 202).

Additionally shown in FIG. 2B are some example locations of the connector(s) 106. In particular examples, the connector(s) 106 are located at the forehead 203, the maxilla facial region 204, and the zygoma facial region 205. Other locations of the connector(s) 106 are herein contemplated. However, the connector(s) 106 in at least these positions can provide a dynamic, yet stable connection between the display 102 and the facial interface 104.

It will be appreciated that the connector(s) 106 at the different locations can be the same, or in certain cases, different. For instance, the connector(s) 106 can include a first joint (e.g., socket joint, soft joint, molded hinge joint, butterfly flexure joint, cam pivot joint, cross axis pivot joint, etc.) positioned at the forehead 203. In addition, the connector(s) 106 can include a second joint, different from the first joint, such as a pivot joint, elastomer spring joint, soft joint, single ball joint, etc. Indeed, different arrangements and types of the connector(s) 106 can be implemented to provide a particular force profile, amount of rigidity, etc.

Similarly, the cushions 114 can be positioned adjacent to a variety of different connectors, but not necessarily each of the connector(s) 106. For example, the cushions 114 can be positioned adjacent to the connector(s) 106 at the forehead 203 and the zygoma facial region 205, but not at the maxilla facial region 204. In other examples, the cushions 114 are positioned adjacent to each of the connector(s) 106.

Furthermore, the cushions 114 can each include the same type of cushion. For example, the cushions 114 positioned proximate to the connector(s) 106 can each be a foam cushion, a C-channel cushion, etc. In other examples, the cushions 114 include different types of cushions, depending on the adjacent connector. For instance, the cushions 114 at the forehead 203 can include a C-channel cushion that partially surround the corresponding connector(s) 106 within a C-channel. In addition, the cushions 114 at the zygoma facial region 205 can include a torus cushion that entirely surrounds the corresponding connector(s) 106 inside the torus. Other examples and combinations of cushions are herein contemplated.

Any of the features, components, and/or parts, including the arrangements and configurations thereof shown in FIG. 2 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 2.

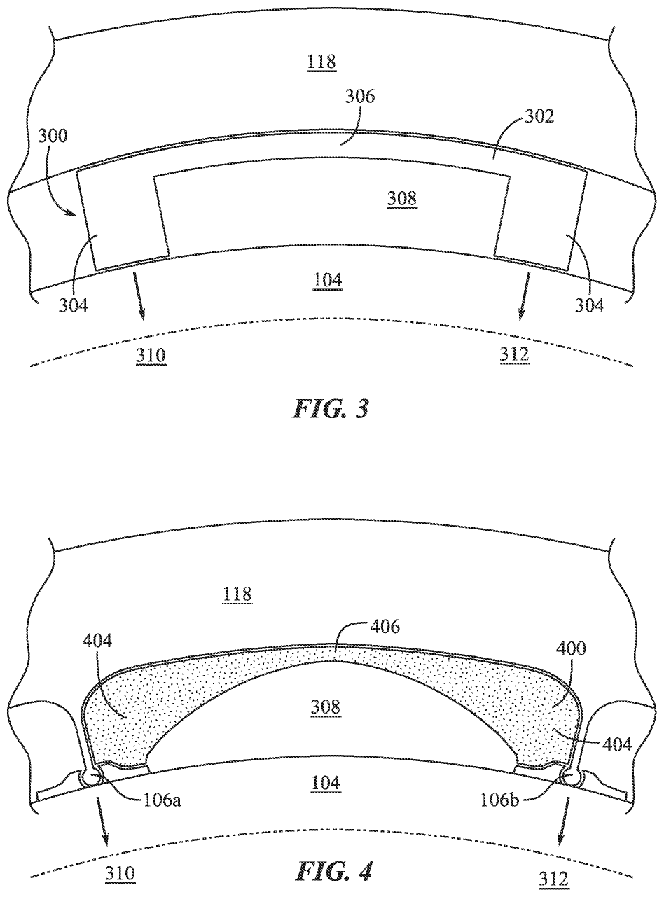

The following section discusses an example cushion implementing a block of material spanning between forehead connectors of a head-mountable device. In particular, FIG. 3 illustrates a cushion 300 in accordance with one or more examples of the present disclosure.

As shown, the cushion 300 is positioned between the facial interface 104 and the light seal frame 118. In particular, the cushion 300 includes an aluminum block 302. The aluminum block 302 can include pillars 304. The pillars 304 are spaced apart to interface with a first forehead region 310 and a second forehead region 312 (e.g., at left and right sides of the forehead 203). In some examples, the pillars 304 are attached to at least one of the facial interface 104 or the light seal frame 118. In particular examples, the pillars 304 are attached to both of the facial interface 104 and the light seal frame 118. Therefore, in some examples, the pillars 304 span an entire distance between the facial interface 104 and the light seal frame 118. In other examples, a gap exists between the pillars 304 and at least one of the facial interface 104 and the light seal frame 118.

Albeit not shown, the pillars 304 can be positioned adjacent to one or more connectors. For example, the pillars 304 can be positioned between forehead connectors, such as pivot connections.

A bridge 306 spans between the pillars 304. In particular, the bridge 306 includes a comparatively thinner section of aluminum compared to the pillars 304. This thinner section allows the bridge 306 to flex in and out (e.g., towards and away from the light seal frame 118) in response to applied forces. In some examples, the bridge 306 can be referred to as an aluminum body, with the pillars 304 being protrusions extending therefrom.

An air pocket 308 positioned between the pillars 304 (and between the bridge 306 and the facial interface 104) can facilitate the pliant movement of the bridge 306 without contacting the facial interface 104. Additionally or alternatively, the air pocket 308 can provide additional cushioning. For example, the air pocket 308 can dampen or slow the flexure of the bridge 306. For instance, the air pocket 308 can be at least partially hermetically sealed, such that air evacuation from the air pocket 308 can be slowed or otherwise inhibited—which in turn can dampen motion of the bridge 306.

In at least some examples, the foregoing configuration of the cushion 300 can provide increased rigidity or support at the forehead-interfacing regions of the head-mountable device. In so doing, some examples can offload an amount of pressure or force transferred to other connectors. That is, the cushion 300 can distribute applied forces to the first forehead region 310 and the second forehead region 312 that could otherwise be distributed to other connectors. In this manner, some implementations of the cushion 300 can reduce pressure points and improve user comfort.

Alternatively to the aluminum block 302, those of ordinary skill in the art will appreciate that other blocks of material can be implemented. For example, a composite material, plastic, or another pliant metal can be implemented in addition to or alternatively to aluminum.

Any of the features, components, and/or parts, including the arrangements and configurations thereof shown in FIG. 3 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 3.

The following section discusses another example cushion, namely a foam cushion, spanning between forehead connectors of a head-mountable device. In particular, FIG. 4 illustrates a foam cushion 400 in accordance with one or more examples of the present disclosure.

As shown, the foam cushion 400 spans between connectors 106a, 106b (which are pivot connections in this particular example). The foam cushion 400 includes pillars 404 in the form of thickened foam sections that are positioned adjacent (or proximate) to the connectors 106a, 106b. The pillars 404 and the connectors 106a, 106b are configured to interface with the forehead regions 310, 312.

The foam cushion 400 further includes a bridge 406 that connects the pillars 404. In particular examples, the bridge 406 is arched—thereby forming a semi-circular surface oriented towards the facial interface 104. The air pocket 308 is positioned between the pillars 404 and the bridge 406. Via the air pocket 308, the bridge 406 can flex towards and away from the light seal frame 118 (e.g., in response to applied forces) as similarly described above in relation to FIG. 3.

The foam cushion 400, compared to the cushion 300, can provide increased amounts of flexibility and comfort for a head-mountable device. The foam cushion 400 can still provide rigidity and support, particularly for distributing applied forces (whether sudden or prolonged). However, the foam cushion 400 can also provide increased flexibility and comfort that can lend to improved user experiences.

To illustrate, the foam cushion 400 can include certain material properties that provide certain advantages of both stiffer materials and softer materials. For instance, the foam cushion 400 can, in response to applied loads, include a compression or displacement profile that is similar to stiffer materials (like metal) over shorter periods of time (e.g., on the order of microseconds to milliseconds). By contrast, the foam cushion 400 can, in response to applied loads, include a compression or displacement profile that is similar to softer materials (like gel) over longer periods of time (e.g., on the order of seconds to minutes).

In some examples, the foam cushion 400 can include a variety of different types of foam. For instance, the foam cushion 400 can include an open cell foam, closed cell foam, polyurethane foam, polyethylene foam, charcoal foam, latex foam, memory foam, high density foam, high resilience foam, cross-linked foam, etc. In certain implementations, the foam cushion 400 includes D30® foam.

Any of the features, components, and/or parts, including the arrangements and configurations thereof shown in FIG. 4 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 4.

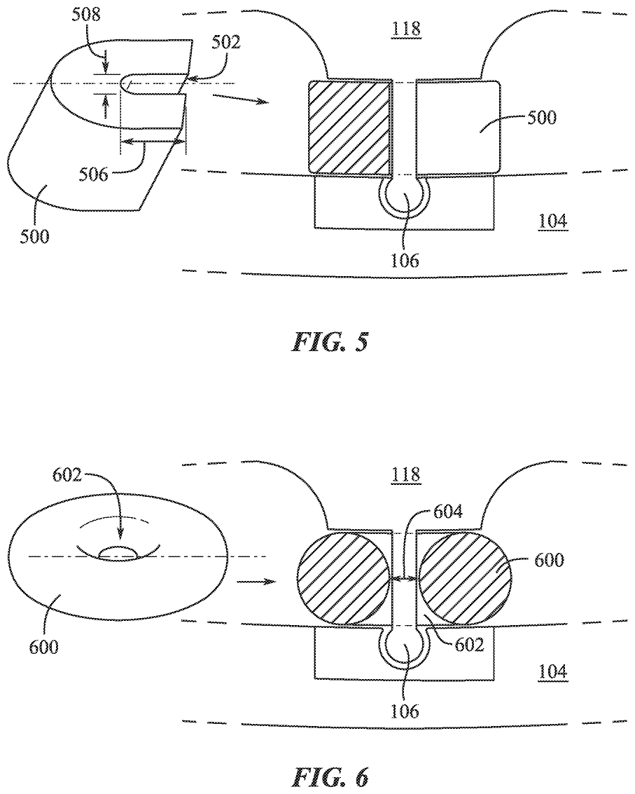

The following sections in relation to FIGS. 5-7 discuss example configurations of a foam cushion. In particular, FIG. 5 illustrates a C-channel foam cushion in accordance with one or more examples of the present disclosure.

As shown, the foam cushion 500 includes a horseshoe surface geometry defining a C-channel 502. In these or other examples, the C-channel 502 is sized and shaped to interface with one of the connector(s) 106. For instance, the foam cushion 500 can be positioned within close proximity of the connector(s) 106 (e.g., to partially encompass or surround one of the connector(s) 106).

The C-channel 502 can have various different dimensions to accommodate insertion of one of the connector(s) 106 within the C-channel 502. To illustrate, the C-channel 502 can have a depth 506 of about one millimeter to about twenty millimeters. Further, the C-channel 502 can have a width 508 of about one millimeter to about ten millimeters. In certain examples, the C-channel 502 is slightly undersized relative to the connector(s) 106, thereby creating a compression fitting between the C-channel walls and the connector(s) 106. Additionally or alternatively, the foam cushion 500 is adhered to the connector(s) 106 within the C-channel 502.

Those of ordinary skill in the art will appreciate that the orientation or opening of the C-channel 502 can be adjusted to a variety of different orientations, as may be desired. In some examples, the C-channel 502 is oriented towards an adjacent connector. Additionally or alternatively, the C-channel 502 is oriented towards or away from a middle region (e.g., a nose bridge) or line of symmetry for a head-mountable device. In other examples, the C-channel 502 is oriented horizontally, vertically, or at another suitable angle. In particular implementations, the C-channel 502 is oriented towards or away from directionally-anticipated shear loads.

In these or other examples, the foam cushion 500 can compress or deform in response to applied loads (i.e., in response to loads applied through at least one of the facial interface 104 or the light seal frame 118). In certain implementations, the foam cushion 500 compresses uniformly. In other implementations, the foam cushion 500 compresses non-uniformly as a function of the geometry and/or orientation of the foam cushion 500. Still, in other implementations, the foam cushion 500 can compress non-uniformly as a function of the angle of the connector(s) 106.

As the foam cushion 500 compresses in response to an applied load, the foam cushion 500 can provide rigidity and support around the connector(s) 106. Further, the foam cushion 500 can also disperse energy from the applied load. For example, the foam cushion 500 can offload some of transferred load that may otherwise transfer through the connector(s) 106 and/or to other portions of the head-mountable device.

Any of the features, components, and/or parts, including the arrangements and configurations thereof shown in FIG. 5 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 5.

FIG. 6 illustrates another example foam cushion 600 in accordance with one or more examples of the present disclosure. As shown, the foam cushion 600 includes a torus foam cushion (e.g., in the shape of an inner tube or doughnut). The foam cushion 600, like the foam cushion 500, can be positioned proximate to one of the connector(s) 106. In particular, the foam cushion 600 can be positioned to fully encompass or surround one of the connector(s) 106.

For example, the connector(s) 106 can be positioned inside a torus center-hole 602 having a torus inner diameter 604. In certain implementations, the torus inner diameter 604 approximates a diameter of the connector(s) 106. For instance, the torus inner diameter 604 can be slightly undersized to form a compression fit against the connector(s) 106. In other instances, the torus inner diameter 604 exactly matches the diameter of the connector(s) 106, while in other instances slightly larger than the diameter of the connector(s) 106 (thereby allowing some movement or play of the foam cushion 600 relative to the connector(s) 106).

In these or other examples, the foam cushion 600 can be free-floating relative to the connector(s) 106. In other examples, the foam cushion 600 can be adhered to the connector(s) 106.

In at least some examples, the foam cushion 600 can provide a universal compression response to applied loads. For example, regardless of the load direction or amount of shear, the foam cushion 600 can provide a same compression response to the applied load. In so doing, the foam cushion 600 can provide support and/or offload an amount of transferred energy that may otherwise travel through the connector(s) 106 and/or to other portions of the head-mountable device.

Any of the features, components, and/or parts, including the arrangements and configurations thereof shown in FIG. 6 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 6.

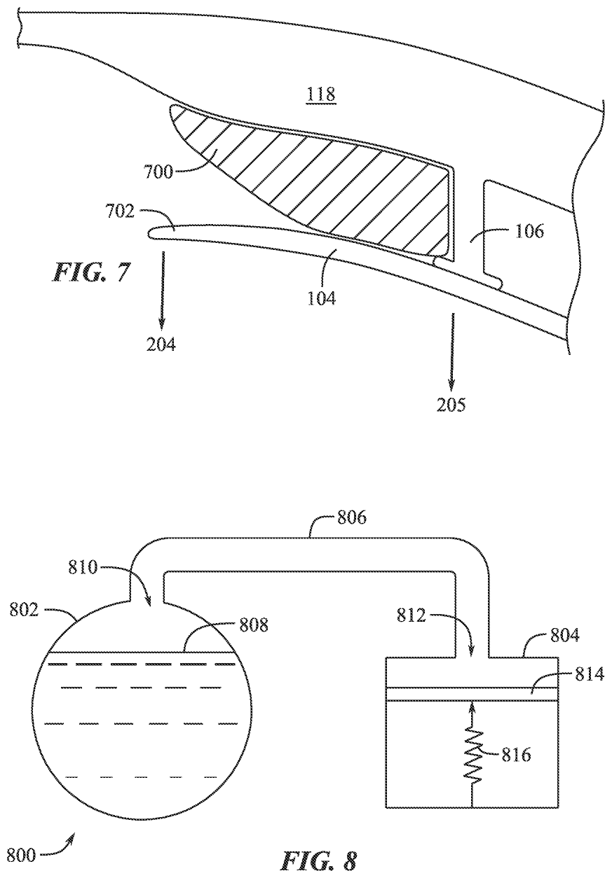

FIG. 7 illustrates yet another foam cushion 700 in accordance with one or more examples of the present disclosure. As shown, the foam cushion 700 is positioned proximate to one of the connector(s) 106 at the zygoma facial region 205. In addition, the foam cushion 700 tapers away from the connector(s) 106 (e.g., away from the zygoma facial region 205 and towards the maxilla facial region 204). Accordingly, the facial interface 104 includes a floating end 704 positioned above a tapered portion of the foam cushion 700. Moreover, with such a taper in the foam cushion 700, the floating end 704 of the facial interface 104 can flex in and out relative to the maxilla facial region 204 and the foam cushion 700.

To illustrate, the floating end 704 can flex towards the light seal frame 118 (and in some cases, contact the tapered portion of the foam cushion 700) in response to an applied load from the facial interface 104. Alternatively, the light seal frame 118 and the foam cushion 700 can pivot, roll, or compress towards the floating end 704 in response to an applied load from the light seal frame 118. In this manner, the foam cushion 700 can provide support and/or offload an amount of transferred energy that may otherwise travel through the connector(s) 106 and/or to other portions of the head-mountable device.

Any of the features, components, and/or parts, including the arrangements and configurations thereof shown in FIG. 7 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 7.

The following section discusses an alternative type of cushion, namely a hydraulic cushion for implementing with a head-mountable device. In particular, FIG. 8 illustrates a hydraulic cushion 800 in accordance with one or more examples of the present disclosure.

As shown, the hydraulic cushion 800 includes a first chamber 802 and a second chamber 804 connected by a fluid path 806. The first chamber 802 includes a fluid 808, such as a liquid or gel. In certain implementations, the fluid 808 includes mineral oil, water, etc.

In response to an applied load to the head-mountable device (as discussed above), the first chamber 802 can be deformed—thereby displacing the fluid 808. In particular, the fluid 808 can travel through an opening 810 in the first chamber 802, through the fluid path 806, and through an opening 812 in the second chamber 804. The rate of fluid travel can determine the amount of provided flexibility (or rigidity).

For example, at least one of the opening 810 or the opening 812 can be sized to limit fluid flux such that the first chamber 802 functions as a stiffer cushion or a softer cushion. In particular, at least one of the opening 810 or the opening 812 can be sized to limit fluid flux such that the first chamber 802 includes the rigidity of a stiffer cushion in immediate response to an applied load or impact (e.g., within the initial microseconds or milliseconds of the applied load). By contrast, at least one of the opening 810 or the opening 812 can be sized to control fluid flux such that the first chamber 802 includes the flexibility of a softer cushion in response to longer durations of an applied load (e.g., after the initial microseconds or milliseconds of the applied load). That is, the fluid 808 may not displace much in a shorter period of time—thereby providing a rigid force response for rapidly applied loads. However, over a longer duration of an applied load, the fluid 808 can displace more to provide the desired flexibility.

Further shown in FIG. 8, the second chamber 804 includes a spring-enforced wall 814. The spring-enforced wall 814 is driven by a spring 816. The spring 816 can compress in response to the fluid 808 forced into the second chamber 804—thereby displacing the spring-enforced wall 814 to increase the usable volume of the second chamber 804. Once the applied load to the first chamber 802 is released, the spring 816 can decompress or push the spring-enforced wall 814 back towards the opening 812 to its resting state. In so doing, the spring-enforced wall 814 can push the fluid 808 back through the opening 812, through the fluid path 806, and through the opening 810 into the first chamber 802.

Any of the features, components, and/or parts, including the arrangements and configurations thereof shown in FIG. 8 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 8.

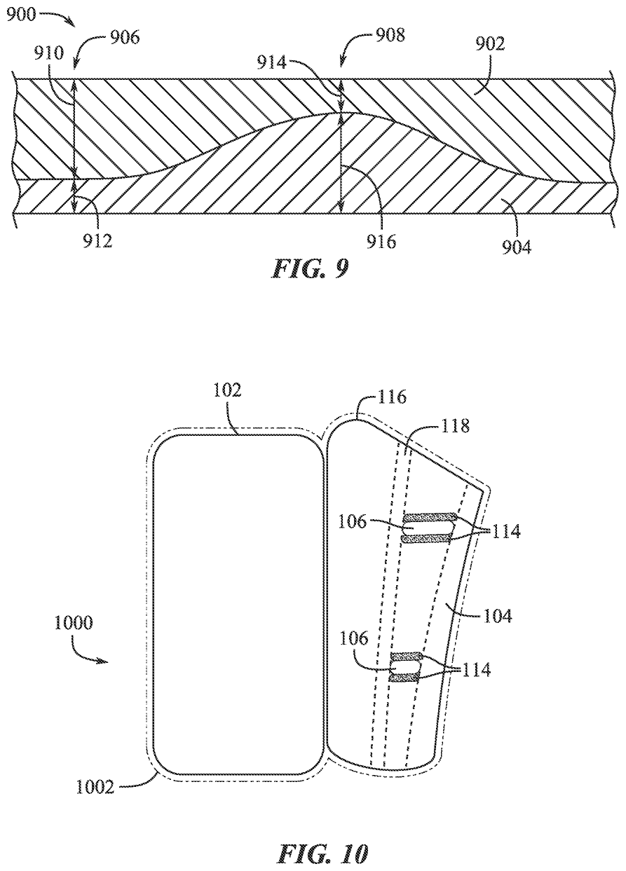

In some examples, foam cushions for head-mountable devices as disclosed herein can be layered. The following section discusses foam layers within a foam cushion. In particular, FIG. 9 illustrates a cross-sectional view of an example foam cushion 900 with multiple layers in accordance with one or more examples of the present disclosure.

As shown, the foam cushion 900 includes a first layer 902 and a second layer 904. In some examples, the first layer 902 and the second layer 904 include a same type of foam material. In other examples, the first layer 902 and the second layer 904 include a different type of foam material. For instance, the first layer 902 can include a soft foam layer, and the second layer 904 can include a hard foam layer. In such a case, the first layer 902 can provide increased flexibility and comfort, while the second layer 904 can provide increased support and impact resistance.

Further shown in FIG. 9, the foam cushion 900 can also have layers with non-uniform (i.e., differing) thicknesses at different foam regions. For instance, at a first foam region 906, the first layer 902 can include a foam thickness 910, and the second layer 904 can include a foam thickness 912. In such an example, the first foam region 906 can provide increased flexibility and comfort by implementing a greater thickness of the first layer 902 compared to the second layer 904.

By contrast, at a second foam region 908, the first layer 902 can include a foam thickness 914, and the second layer 904 can include a foam thickness 916. In such an example, the second foam region 908 can provide increased support and impact resistance by implementing a greater thickness of the second layer 904 compared to the first layer 902. In this manner, the foam cushion 900 can provide desired material properties that differ along the foam cushion 900 (e.g., at specific locations for supportive yet comfortable wear).

Any of the features, components, and/or parts, including the arrangements and configurations thereof shown in FIG. 9 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 9.

One or more cushions can be implemented in addition to or alternatively to the foregoing types of cushions between the facial interface 104 and the light seal frame 118. The following sections in relation to FIGS. 10-12 discuss such example cushions. In particular, FIG. 10 illustrates a head-mountable device 1000 implementing an overmold cushion 1002 in accordance with one or more examples of the present disclosure.

As shown, the head-mountable device 1000 includes the same or similar elements as the head-mountable device 100 described above. In addition, however, the head-mountable device 1000 includes the overmold cushion 1002. In particular, the overmold cushion 1002 at least partially envelops or surrounds the head-mountable device 1000. For example, the overmold cushion 1002 covers an exterior surface of both the display 102 and the light seal 116. In particular implementations, the overmold cushion 1002 covers an entirety of the exterior for both the display 102 and the light seal 116, including the facial interface 104. In other implementations, the overmold cushion 1002 covers only a portion of the exterior for the display 102 and the light seal 116. For instance, the facial interface 104 can be devoid of the overmold cushion 1002.

The overmold cushion 1002 can include a variety of different cushion materials as described above. In particular implementations, the overmold cushion 1002 can include foam. In other implementations, the overmold cushion 1002 can include silicone.

In at least some examples, the overmold cushion 1002 can provide additional comfort, flexure, and/or support. For example, the overmold cushion 1002 can absorb energy from applied loads and/or distribute such energy. In other examples, the overmold cushion 1002 can be tensioned or shaped to promote flexure (or bound an amount of flexure) between components of the head-mountable device 1000.

Any of the features, components, and/or parts, including the arrangements and configurations thereof shown in FIG. 10 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 10.

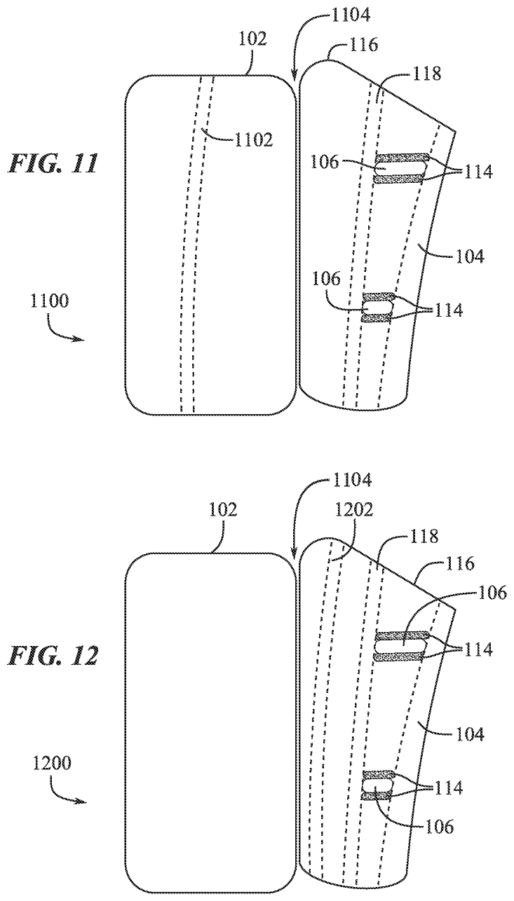

FIG. 11 illustrates a head-mountable device 1100 implementing a display cushion 1102 in accordance with one or more examples of the present disclosure. The head-mountable device 1100 includes the same or similar elements as the head-mountable device 100 described above. Differently however, the head-mountable device 1100 includes the display cushion 1102 that corresponds to the display 102.

In some examples, the display cushion 1102 includes a layer of cushioning (e.g., a foam layer) positioned within the body of the display 102. For instance, the display cushion 1102 can wrap around a perimeter of one or more lenses within the display 102. Additionally or alternatively, the display cushion 1102 can be positioned within the body of the display 102 between a lens of the display 102 and the display-light seal interface 1104 (where “display-light seal interface” is a reference plane where the light seal 116 abuts, adjoins, or is positioned proximate to the display 102).

In these or other examples, the display cushion 1102, like the overmold cushion 1002, can provide additional comfort, flexure, and/or support. For example, the display cushion 1102 can absorb energy from applied loads and/or distribute such energy. In other examples, the display cushion 1102 can be tensioned or shaped to promote flexure (or bound an amount of flexure) between components positioned within the display 102.

Those of ordinary skill in the art will appreciate that the display cushion can be sized, shaped, and oriented in a variety of different ways. Indeed, the display cushion 1102 can be oriented substantially vertical (as shown). Alternatively, the display cushion 1102 can be oriented substantially horizontal, or at another suitable angle as may be desired.

Any of the features, components, and/or parts, including the arrangements and configurations thereof shown in FIG. 11 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 11.

FIG. 12 illustrates a head-mountable device 1200 implementing a light seal cushion 1202 in accordance with one or more examples of the present disclosure. The head-mountable device 1200 includes the same or similar components as the head-mountable device 100 described above. However, the head-mountable device 1200 further includes the light seal cushion 1202 positioned within the light seal 116. In particular, the light seal cushion 1202 is positioned between the light seal frame 118 and the display-light seal interface 1104.

As with other cushions described herein, the light seal cushion 1202 can include a variety of different materials, sizes, and configurations. In particular implementations, the light seal cushion 1202 can include a layer of foam cushion. In these or other examples, the light seal cushion 1202 can include a stiffer foam material with a first amount of stiffness (e.g., for increased support or rigidity), and the cushions 114 can include a comparatively softer foam cushion with a second amount of stiffness less than the first amount of stiffness (e.g., for increased flexure and comfort). As used herein, the term “stiffness” can refer to a compressibility of a cushion. For example, a stiffness can include an amount of resistance to an applied load, a spring constant, or other suitable metric. Formed in series in this manner, a user can experience or feel a variety of different material property advantages due to the light seal cushion 1202 and the cushions 114.

The present technology can, in some examples, collect, store, use, and/or distribute personal information. While not necessary for the operation of the present technology, access and use of such information can improve or customize the present technology to a specific user. If such personal information is used, it should be used according to secure, well established and accepted procedures and protocols that protect the user from unauthorized collection, use, or distribution.

The present description describes the exemplary systems and method using specific nomenclature to provide a thorough understanding of the described examples. However, the specific details provided herein are not required in order to practice the described examples. Rather, the foregoing descriptions are presented for purposes of illustration and explanation. They are not target to be exhaustive or to limit the embodiments to the precise forms disclosed. Many modifications and variations are possible in view of the above teachings.

What is claimed is:

1. An apparatus, comprising:
a head-mountable display;
a facial interface;
a connector between the head-mountable display and the facial interface;
a cushion positioned proximate to the connector; and
a wearable strap connected to at least one of the head-mountable display or the facial interface.

2. The apparatus of claim 1, wherein the cushion comprises:
an aluminum body;
a first protrusion extending from the aluminum body; and
a second protrusion extending from the aluminum body.

3. The apparatus of claim 1, wherein the cushion comprises a foam cushion.

4. The apparatus of claim 3, wherein the foam cushion defining a channel, the connector being positioned within the channel.

5. The apparatus of claim 3, wherein the foam cushion comprises a foam torus defining a center hole, the connector being positioned inside the center hole.

6. The apparatus of claim 1, wherein the cushion comprises a hydraulic cushion.

7. The apparatus of claim 6, wherein the hydraulic cushion comprises:
a first chamber at least partially filled with liquid;
a second chamber; and
a fluid path between the first chamber and the second chamber, the second chamber comprising a spring-enforced wall.

8. The apparatus of claim 1, wherein the connector comprises at least one of a forehead connection or a cheek connection.

9. A wearable apparatus, comprising:
a facial interface;
a movable display;
a pivot connection movably constraining the movable display and the facial interface at a forehead region; and
a foam cushion positioned at least partially around the pivot connection.

10. The wearable apparatus of claim 9, further comprising:
an additional pivot connection at a zygoma region; and
an additional foam cushion positioned proximate to the additional pivot connection.

11. The wearable apparatus of claim 10, wherein the additional foam cushion tapers away from the additional pivot connection.

12. The wearable apparatus of claim 10, wherein the facial interface comprises a floating end positioned above the additional foam cushion at a maxilla region.

13. The wearable apparatus of claim 9, further comprising an additional pivot connection positioned at the forehead region, wherein the foam cushion extends between the pivot connection and the additional pivot connection.

14. The wearable apparatus of claim 13, wherein the foam cushion defines an air pocket between the pivot connection and the additional pivot connection.

15. A head-mountable device, comprising:
a display;
a display frame housing the display;
a facial interface;
a wearable strap connected to at least one of the display frame or the facial interface;
a light seal between the display and the facial interface; and
a cushion positioned on or within at least one of the display frame or the light seal, the cushion comprising one of a foam cushion or a hydraulic cushion.

16. The head-mountable device of claim 15, further comprising:
a light seal frame;
a pivot connection between the facial interface and the light seal frame; and
an additional cushion positioned proximate to the pivot connection.

17. The head-mountable device of claim 16, wherein:
the cushion comprises a first amount of stiffness; and
the additional cushion comprises a second amount of stiffness less than the first amount of stiffness.

18. The head-mountable device of claim 15, wherein the cushion comprises an overmold of foam material.

19. The head-mountable device of claim 15, wherein the cushion comprises:
a first cushion layer material; and
a second cushion layer material different than the first cushion layer material.

20. The head-mountable device of claim 19, wherein the first cushion layer material and the second cushion layer material have varying thicknesses.
